(19) United States
(12) Patent Application Publication
(10) Pub. No.: US 2025/0146326 A1
(43) Pub. Date: May 8, 2025

(54) INTELLIGENT LOCKSET AND DOOR

(71) Applicants: Liheng HU, Zhongshan (CN); Yu Chun HUANG, Zhongshan (CN)

(72) Inventors: Liheng HU, Zhongshan (CN); Yu Chun HUANG, Zhongshan (CN)

(21) Appl. No.: 18/903,402

(22) Filed: Oct. 1, 2024

(30) Foreign Application Priority Data
Nov. 6, 2023 (CN) 202311463410.5
Jan. 29, 2024 (CN) 202410118809.8

(51) Int. Cl. E05B 47/00; E05B 9/02

(52) U.S. Cl. CPC E05B 47/0012; E05B 9/02; E05B 2047/0017; E05B 2047/002; E05B 2047/0036; E05B 2047/0069

(57) ABSTRACT

Disclosed are an intelligent lockset and a door. The intelligent lockset includes a first base, a lock body and a transmission mechanism. The lock body includes a lock case and a latch assembly, the lock case is connected to the first base, and the latch assembly is movably disposed in the lock case and is capable of extending or retracting relative to the lock case. The transmission mechanism includes a follower, a transmission assembly and a knob shaft, the follower is rotatably disposed in the lock case and is in transmission connection with the latch assembly, the transmission assembly is rotatably disposed on the first base, and the knob shaft is configured to penetrate the follower and the transmission assembly. The transmission assembly is capable of rotating under driving of a driving mechanism, and drives the follower to rotate through the knob shaft.

### CROSS-REFERENCE TO RELATED APPLICATIONS

The present application claims priority to Chinese Patent Application No. 202311463410.5, filed on Nov. 6, 2023, and Chinese Patent Application No. 202410118809.8, filed on Jan. 29, 2024. The disclosures of the aforementioned applications are hereby incorporated by reference in their entireties.

### TECHNICAL FIELD

The present disclosure relates to the field of lockset technologies, and in particular, to an intelligent lockset and a door.

### BACKGROUND

An intelligent lockset has characteristics of security and convenience and anti-theft function, and it meets the needs of public users, and is recognized by most users. The intelligent lockset becomes a product in the smart home period.

The intelligent lockset in the market generally has two unlocking modes: a mechanical unlocking mode and an electrical unlocking mode. In order to have these two unlocking functions, an internal structure of the intelligent lockset generally includes more parts. However, the more parts occupy a large space, resulting in a size of the intelligent lockset in the market is generally larger, which is not conducive to transportation and installation of the intelligent lock.

### SUMMARY

Embodiments of the present disclosure aim to provide an intelligent lockset and a door, to solve the above-mentioned problem. The embodiment of the present disclosure achieves the above-mentioned purpose by the following technical solutions.

In a first aspect, the present disclosure provides an intelligent lockset, including:
a first base;
a lock body, including a lock case and a latch assembly, the lock case being connected to the first base, and the latch assembly being movably disposed in the lock case and being capable of extending or retracting relative to the lock case; and
a transmission mechanism, including a follower, a transmission assembly and a knob shaft, the follower being rotatably disposed in the lock case and being in transmission connection with the latch assembly, the transmission assembly being rotatably disposed on the first base, the knob shaft being configured to penetrate the follower and the transmission assembly, and the transmission assembly being capable of rotating under driving of a driving mechanism, and driving the follower to rotate through the knob shaft.

In an embodiment, the intelligent lockset further includes a controller and a first switch, the first switch is disposed on a rotation path of the transmission assembly, and is electrically connected to the controller and the driving mechanism, to send a first stopping signal when the transmission assembly drives the latch assembly to extend to a maximum extension position, and the controller controls the driving mechanism to stop running according to the first stopping signal.

In an embodiment, the intelligent lockset further includes a controller and a second switch, the second switch is disposed on a rotation path of the transmission assembly, and is electrically connected to the controller and the driving mechanism, to send a second stopping signal when the transmission assembly drives the latch assembly to retract to a maximum retraction position, and the controller controls the driving mechanism to stop running according to the second stopping signal.

In an embodiment, the intelligent lockset further includes a second switch disposed at intervals with the first switch in a circumferential direction of the transmission assembly, the second switch is electrically connected to the controller and the driving mechanism, to send a second stopping signal when the transmission assembly drives the latch assembly to retract to a maximum retraction position, and the controller controls the driving mechanism to stop running according to the second stopping signal.

In an embodiment, the transmission assembly includes a rotating seat and a transmission member, the rotating seat is rotatably disposed on the first base, and is coaxially disposed with the follower, the knob shaft is configured to penetrate the rotating seat, the transmission member is sleeved on the rotating seat, and the driving mechanism is in transmission connection with the transmission member, to make the transmission member drive the rotating seat to rotate.

In an embodiment, an outer peripheral surface of the rotating seat is convexly provided with a boss, an inner peripheral surface of the transmission member is provided with an arc-shaped slot, the boss is at least partially disposed in the arc-shaped slot, and a width of the boss is smaller than a length of the arc-shaped groove.

In an embodiment, the rotating seat includes a rotating body and a protruding column, the rotating body and the protruding column are substantially cylindrical structures, the protruding column is farther away from the first base relative to the rotating body, and a diameter of the protruding column is smaller than a diameter of the rotating body, and the boss is convexly disposed on an outer peripheral surface of the protruding column, where the rotating body is rotatably disposed on the first base, and is coaxially disposed with the follower, the transmission member is sleeved on the rotating body, and the knob shaft is configured to penetrate the rotating body and the protruding column.

In an embodiment, the transmission assembly further includes a transmission shifting piece which is sleeved on the rotating seat, the transmission shifting piece is provided with a transmission slot matching with the protrusion, the intelligent lockset further includes a first switch and a second switch, the first switch is configured to indicate a maximum extension position of the latch assembly, the second switch is configured to indicate a maximum retraction position of the latch assembly, and the first switch and the second switch are disposed on a rotation path of the transmission shifting piece.

In one embodiment, the lock case includes a bottom plate and a face plate, the face plate is covered on the bottom plate, the follower includes a main body part and a latch shifting rod extending outwards from the main body part, the main body part is rotatably disposed on the bottom plate, and the latch shifting rod is configured to penetrate the latch assembly.

In one embodiment, the main body part includes a first side surface, a second side surface and a third side surface which are sequentially connected along a circumferential direction of the main body part, the latch shifting rod is convexly disposed on the third side surface, the lock body further includes an elastic piece, and the elastic piece is disposed in the lock case, and selectively abuts against the first side surface or the second side surface.

In one embodiment, the lock case further includes a lining plate, an outer sleeve and an inner sleeve, the outer sleeve is sleeved on the inner sleeve, the lining plate is connected to a side of the outer sleeve, and the latch assembly is configured to penetrate the inner sleeve and the lining plate, and is capable of extending or retracting relative to the lining plate.

In one embodiment, the latch assembly includes a latch body and a latch connecting member, the latch connecting member is capable of moving along a length direction of the face plate under driving of the follower, and the latch body is connected to an end of the latch connecting member, and is capable of extending or retracting relative to the lining plate, where the latch body includes an installing hole and a connecting hole, the installing hole is disposed along an axial direction of the latch body, and is configured for installing the latch body to the latch connecting member, and the connecting hole is disposed along a radial direction of the latch body, on an end of the latch body close to the latch connecting member, and communicates with the installing hole, to make the connecting member pass through the connecting hole and be fixedly connected to the latch connecting member.

In one embodiment, the latch connecting member includes a connecting section and a transmission section which are connected to each other, and the connecting member is capable of being connected to the connecting section by passing through the connecting hole.

In one embodiment, the connecting section is provided with a first groove and a second groove which are sequentially disposed along a length direction of the face plate, where the second groove is farther away from the latch connecting member relative to the first groove, and one of the first groove and the second groove is capable of corresponding to the connecting hole, to make the connecting member selectively abut against a groove bottom of one of the first groove and the second groove by passing through the connecting hole, to fix the latch connect member to the latch body.

In one embodiment, the connecting section is further provided with a communicating slot, and the first groove communicates with the second groove through the communicating slot, to make the connecting member be capable of moving from a position corresponding to the first groove to a position corresponding to the second groove through the communicating slot.

In one embodiment, a side of the transmission section away from the face plate is further provided with a protrusion, the bottom plate is further provided with a guiding slot extending along a length direction of the face plate, and the protrusion is configured to penetrate the guiding slot, and is configured to limit a moving direction of the latch connecting member, to make the latch connecting member moves along the length direction of the face plate.

In one embodiment, the intelligent lockset further includes a second base, the first base and the second base are disposed on two opposite sides of the lock body, and the first base and the second base are symmetrically disposed with respect to a central axis of the lock body.

In one embodiment, the intelligent lockset further includes a resetting detection switch and a controller, the resetting detection switch is disposed on a rotation path of the transmission member, and is electrically connected to the driving mechanism, to send a resetting normal signal when the transmission member is reset to an initial state, and the controller controls the driving mechanism to stop running according to the resetting normal signal.

In one embodiment, the intelligent lockset further includes a controller, the controller is electrically connected to the driving mechanism, and is capable of determining whether the driving mechanism is locked-rotor according to a current signal of the driving mechanism, when the controller determines that the driving mechanism is locked-rotor according to the current signal, the controller sends out a reversing signal to the driving mechanism, and the driving mechanism is rotated reversely according to the reversing signal, to make an extension direction and a retraction direction of the latch assembly match with an opening manner of a door, to achieve automatic reversing.

The intelligent lockset provided by the present disclosure includes the first base, the lock body, and the transmission mechanism. The lock body includes the lock case and the latch assembly, the lock case is connected to the first base, and the latch assembly is movably disposed in the lock case, and is capable of extending or retracting relative to the lock case. The transmission mechanism includes the follower, the transmission assembly, and the knob shaft. The follower is rotatably disposed in the lock case, and is in transmission connection with the latch assembly. The transmission assembly is rotatably disposed on the first base, and the knob shaft is configured to penetrate the follower and the transmission assembly. The transmission assembly is rotated under driving of the driving mechanism, and drives the follower to rotate through the knob shaft. For example, the driving mechanism is in transmission connection with the transmission assembly, to drive the transmission assembly to rotate, and then the transmission assembly drives the follower to rotate through the knob shaft.

In this way, on the one hand, the driving mechanism may drive the transmission assembly to rotate, and the transmission assembly drives the follower to rotate through the knob shaft, so that the latch assembly is driven to extend or retract relative to the lock case, and thus electric locking or the electric unlocking of the intelligent lockset is achieved. On the other hand, the knob shaft may be manually rotated to drive the follower to rotate, so that mechanical locking or the mechanical unlocking of the intelligent lockset is achieved. The intelligent lockset is capable of being applied to a scenario of a left-handed door or a scenario of a right-handed door, so that different requirements of opening of the door is met. Since the knob shaft is configured to penetrate the follower and the transmission assembly, so that the follower and the transmission assembly are arranged along an axial direction of the knob shaft, then a space occupied by the follower and the transmission assembly is reduced, thereby realizing miniaturization of the intelligent lockset, and thus convenience of transportation and installation of the intelligent lockset is improved.

In a second aspect, the present disclosure also provides a door, the door is provided with the intelligent lockset mentioned in the first aspect.

The door according to the present disclosure is provided with the above-mentioned intelligent lockset, and has the corresponding technical effects. The specific technical effects are referred to the description of the intelligent lockset, which will not be repeated herein.

These aspects or other aspects of the present disclosure will be more concise and understandable in the description of the following embodiments.

### BRIEF DESCRIPTION OF THE DRAWINGS

The present disclosure, in order to explain technical solutions in embodiments of the present disclosure more clearly, the drawings needed in the description of the embodiments will be briefly introduced below. Obviously, the drawings described below are merely some embodiments of the present disclosure. For a person skilled in the art, other drawings may be obtained according to these drawings without creative labor.

FIG. 1 is a schematic structural diagram of an intelligent lockset provided by the present disclosure.

FIG. 2 is a schematic structural diagram of the intelligent lockset shown in FIG. 1 when a latch assembly extends.

FIG. 3 is a schematic structural diagram of the intelligent lockset shown in FIG. 1 when the latch assembly retracts.

FIG. 4 is a schematic structural diagram of a first base, a transmission assembly and a driving mechanism of the intelligent lockset in a locked state which is shown in FIG. 1.

FIG. 5 is a schematic structural diagram of the first base, the transmission assembly, and the driving mechanism of the intelligent lockset in an unlocked state which is shown in FIG. 1.

FIG. 6 is an exploded diagram of the first base, the transmission assembly, and the driving mechanism of the intelligent lockset shown in FIG. 1.

FIG. 7 is an assembly schematic diagram of a rotating seat and a transmission member of the intelligent lockset shown in FIG. 1.

FIG. 8 is a schematic structural diagram of a lock body of the intelligent lockset shown in FIG. 1.

FIG. 9 is an exploded diagram of the lock body shown in FIG. 8.

FIG. 10 is a schematic structural diagram of a latch assembly of the lock body shown in FIG. 8.

FIG. 11 is another schematic structural diagram of the latch assembly of the lock body shown in FIG. 10.

FIG. 12 is an assembly diagram of the latch assembly and a follower of the intelligent lockset shown in FIG. 1.

FIG. 13 is another schematic structural diagram of the intelligent lockset provided by the present disclosure.

FIG. 14 is a schematic structural diagram of a first switch, a second switch, a resetting detection switch and a controller of an intelligent lockset according to another embodiment provided by the present disclosure.

FIG. 15 is another schematic structural diagram of the first switch, the second switch, the resetting detection switch and the controller of the intelligent lockset shown in FIG. 14.

FIG. 16 is a schematic structural diagram of a knob of an intelligent lockset in an unlocked state according to another embodiment provided by the present disclosure.

FIG. 17 is another schematic structural diagram of the knob of the intelligent lockset in a locked state which is shown in FIG. 16.

FIG. 18 is an exploded diagram of a first base, a transmission assembly, and a driving mechanism of an intelligent lockset according to another embodiment provided by the present disclosure.

### DETAILED DESCRIPTION OF THE EMBODIMENTS

In order to facilitate the understanding of embodiments of the present disclosure, the embodiments of the present disclosure will be described more comprehensively below with reference to relevant drawings. Preferred implementations of the present disclosure are shown in the drawings. The present disclosure may be implemented in many different forms, and is not limited to the embodiments described in the present article. These embodiments are provided to make content of the present disclosure more thorough and comprehensive.

Unless otherwise defined, all technical and scientific terms used in the present article have the same meaning as commonly understood by a person skilled in the technical field of the present disclosure. The terms used in the embodiments of the present disclosure are merely for describing specific embodiments, and are not intended to limit the present disclosure.

Inventors of the present disclosure find that, an intelligent lockset in the market usually has two unlocking modes, which are mechanical unlocking and electrical unlocking, that is, it may be unlocked not only by rotating a handle or a knob, but also by intelligent modes including but not limited to recognition of a fingerprint, input of a password, an electronic card, recognition of face, or controlled by an application (app software of a mobile phone) and the like. In order to have these two unlocking functions, an internal structure of the intelligent lockset usually includes many parts, such as a knob shaft, a motor, and transmission components. A mode of assembly of multiple parts of the intelligent lockset in the market will increase a space occupied by the parts, resulting in a size of the intelligent locks in the market being generally larger, which is not conducive to transportation and installation of the intelligent lock. In addition, the intelligent lockset in the market is not capable of being adapted to a traditional mechanical lock.

In order to improve at least a portion of the problems above-mentioned, a first aspect of the present disclosure provides an intelligent lockset. According to the present disclosure, a driving mechanism drives the transmission assembly to rotate, and then a transmission assembly drives a follower to rotate through a knob shaft, so that the latch assembly is driven to extend or retract relative to a lock case, and thus the intelligent lockset is locked or unlocked. In addition, the knob shaft may be rotated manually to drive the follower to rotate, so that mechanical locking or mechanical unlocking of the intelligent lockset is realized. Since the knob shaft is configured to penetrate the follower and the transmission assembly, so that the follower and the transmission assembly are disposed along an axial direction of the knob shaft, then a space occupied by the follower and the transmission assembly is reduced, and then miniaturization of the intelligent lockset is realized, and thus convenience of transportation and installation of the intelligent lockset is improved. The intelligent lockset provided by the present disclosure will be described in detail below in combination with the specific embodiments and the drawings.

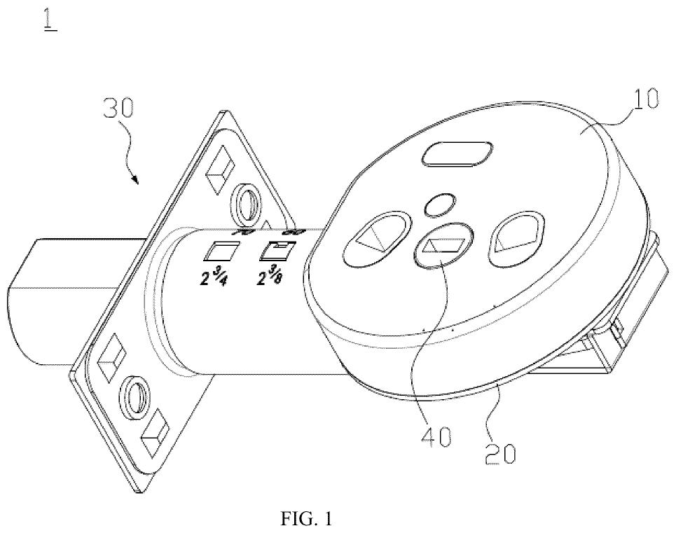

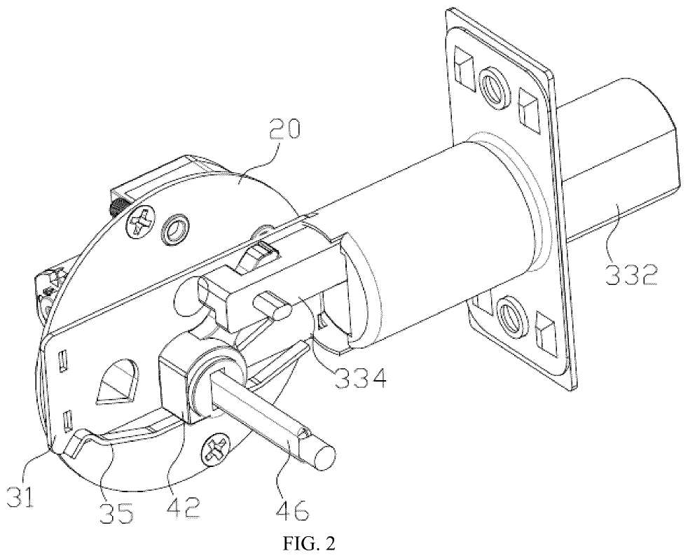

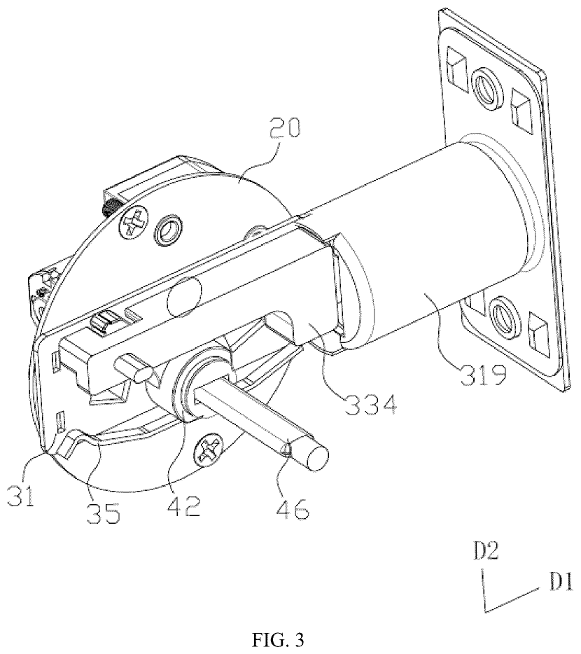

Please refer to FIGS. 1 to 5, an embodiment of the present disclosure provides an intelligent lockset 1. This intelligent lockset 1 includes a first base 10, a lock body 30, and a transmission mechanism 40. The lock body 30 includes a lock case 31 and a latch assembly 33. The lock case 31 is connected to the first base 10, and the latch assembly 33 is movably disposed in the lock case 31, and is capable of extending or retracing relative to the lock case 31. The transmission mechanism 40 includes a follower 42, a transmission assembly 44 and a knob shaft (also called a spindle) 46. The follower 42 is rotatably disposed in the lock case 31, and is in transmission connection with the latch assembly 33. The transmission assembly 44 is rotatably disposed on the first base 10, and the knob shaft 46 is configured to penetrate the follower 42 and the transmission assembly 44. The transmission assembly 44 is capable of rotating under driving of the driving mechanism 50, and drives the follower 42 to rotate though the knob shaft 46.

In some embodiments, the driving mechanism 50 is in transmission connection with the transmission assembly 44, to drive the transmission assembly 44 to rotate, and the transmission assembly 44 drives the follower 42 to rotate through the knob shaft 46.

Based on this, on the one hand, the driving mechanism 50 may drive the transmission assembly 44 to rotate, and then the transmission assembly 44 drives the follower 42 to rotate through the knob shaft 46, so that the latch assembly 33 is driven to extend or retract relative to the lock case 31, and thus electric locking or electric unlocking of the intelligent lockset 1 is achieved. On the other hand, the knob shaft 46 may be manually rotated to drive the follower 42 to rotate, so that mechanical locking or mechanical unlocking of the intelligent lockset 1 is achieved. The intelligent lockset 1 is capable of being applied to a scenario of a left-handed door or a scenario of a right-handed door, so that different requirements of opening of the door is met. Since the knob shaft 46 is configured to penetrate the follower 42 and the transmission assembly 44, so that the follower 42 and the transmission assembly 44 are disposed along an axial direction of the knob shaft 46, then a space occupied by the follower 42 and the transmission assembly 44 (for example a transmission assembly of a motor) is reduced, thereby realizing miniaturization of the intelligent lockset 1, and thus the convenience of transportation and installation of the intelligent lockset 1 is improved.

In some embodiments, the first base 10 may be used for installing the driving mechanism 50 and a portion of the transmission mechanism 40. In some embodiments, the first base 10 is substantially a hollow cylindrical structure. In other embodiments, the first base 10 may also be a hollow cuboid structure and the like, which may be set according to the actual situation.

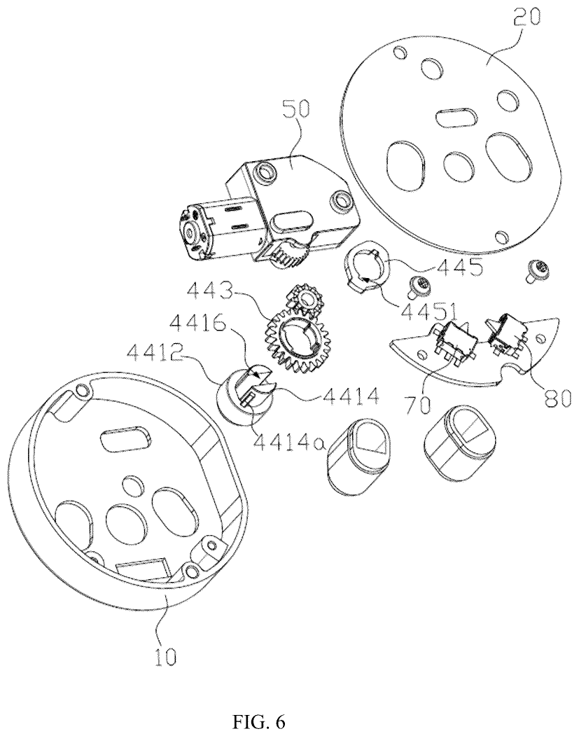

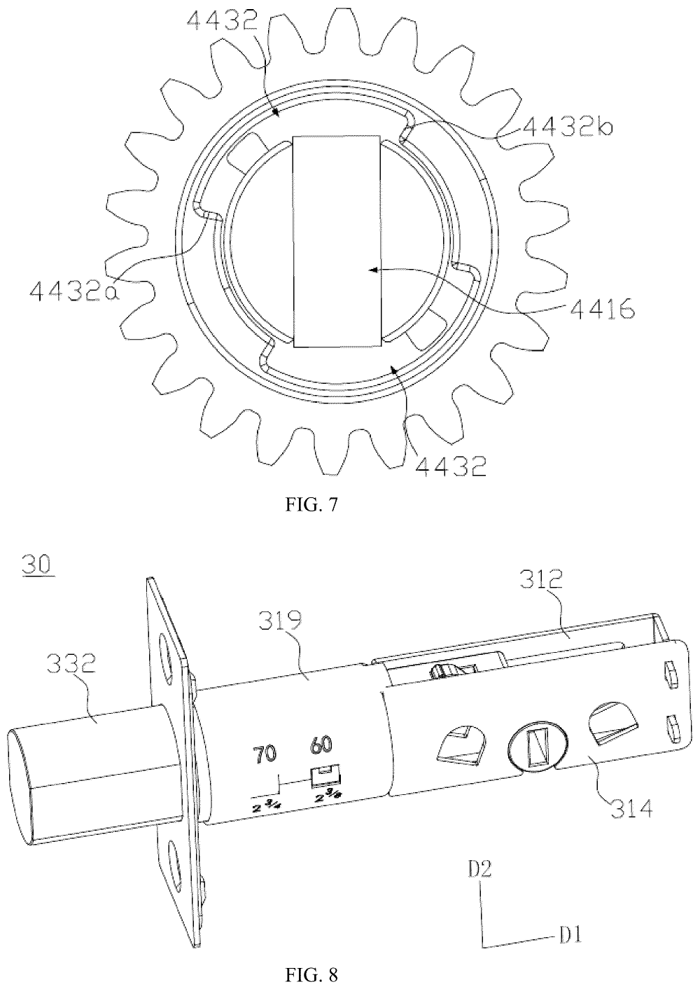

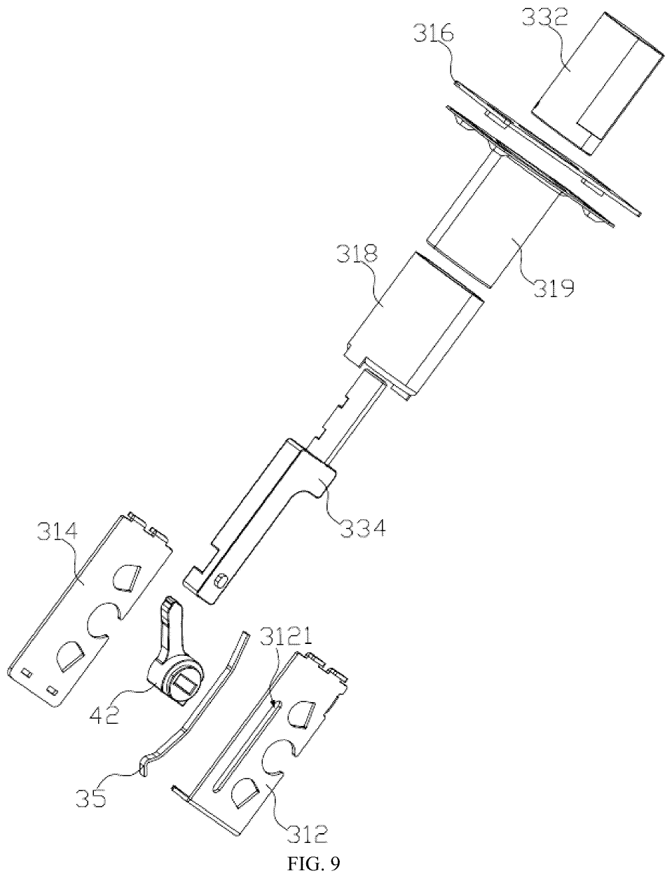

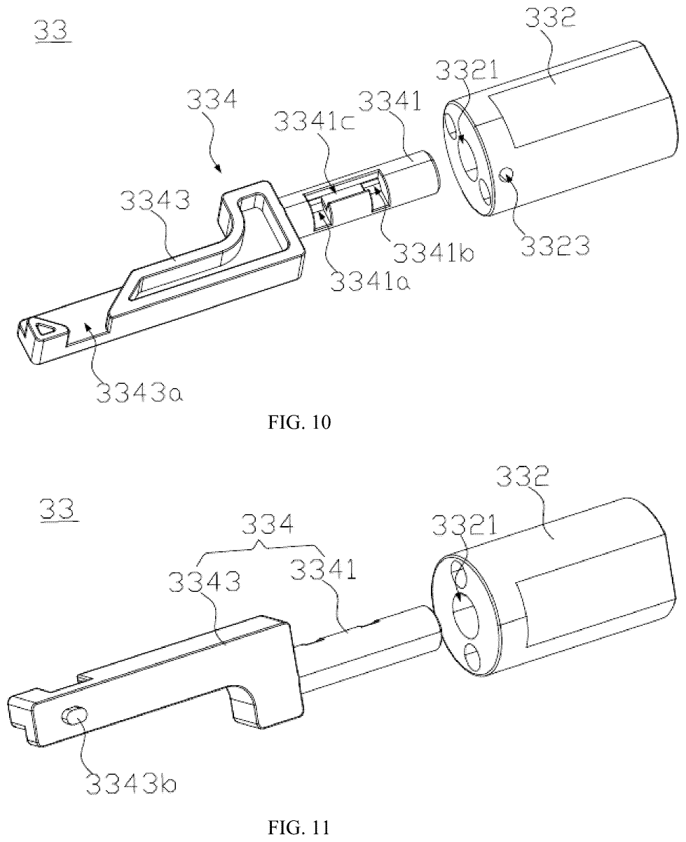

Please refer to FIGS. 6 to 11, in some embodiments, the intelligent lockset 1 further includes a first cover plate 20, and the first cover plate 20 is covered on the first base 10 to enclose the driving mechanism 50 and a portion of the transmission mechanism 40. The first cover plate 20 may be fixed to the first base 10 by a screw, and may also be fixed to the first base 10 by bonding or clamping and the like. The shape of the first cover plate 20 matches with the shape of the first base 10. Consequently, in some embodiments, the first cover plate 20 has a substantially circular plate-like structure. In other embodiments, when the first base 10 has a cuboid structure, the first cover plates 20 may also be a rectangular plate-like structure.

In some embodiments, the lock body 30 includes a lock case 31 and a latch assembly 33, the lock case 31 is connected to the first base 10, and the lock case 31 may be used for installing the latch assembly 33 and the follower 42. The lock case 31 is approximately disposed in the middle of the first base 10, so that appearance consistency of the intelligent lockset 1 may be improved. The latch assembly 33 is movably disposed in the lock case 31, and is capable of extending or retracting relative to the lock case 31. When the latch assembly 33 extends relative to the lock case 31, locking of the intelligent lockset 1 is achieved. When the latch assembly 33 is retracted relative to the lock case 31, unlocking of the intelligent lockset 1 is achieved. The latch assembly 33 has a maximum extension position and a maximum retraction position. Among them, the maximum extension position refers to a limit position of the latch assembly 33 when the latch assembly 33 extends to a maximum length relative to the lock case 31, and the maximum retraction position refers to a limit position of the latch assembly 33 when the latch assembly 33 is retracted to a minimum length relative to the lock case 31.

In some embodiments, the lock case 31 includes a bottom plate 312 and a face plate 314, the face plate 314 is covered on the bottom plate 312, and the face plate 314 and the bottom plate 312 may be connected into an integral structure in a plug-in manner. In some embodiments, the face plate 314 is substantially a rectangular plate structure, and is disposed opposite to the first cover plates 20. The bottom plate 312 is substantially an “L”-shaped plate structure, and is located on a side of the lock case 31 away from the first cover plate 20. In other embodiments, the bottom plate 312 may be opposite to the first cover plate 20, and the face plate 314 may be located on a side of the lock case 31 away from the first cover plate 20. The face plate 314 has a length direction D1 and a width direction D2 which is perpendicular to the length direction D1.

In some embodiments, the lock case 31 further includes a lining plate (also called a latch plate) 316, an outer sleeve 318 and an inner sleeve 319. The outer sleeve 318 is substantially a barrel-shaped structure, and is sleeved on the inner sleeve 319. The outer sleeve 318 and the inner sleeve 319 are disposed on a side of the face plate 314 along the length direction D1 of the face plate 314. The lining plate 316 is connected to a side of the outer sleeve 318 and the inner sleeve 319 away from the face plate 314, and is used for being connected to a doorframe to install the intelligent lockset 1 on the doorframe. The latch assembly 33 is configured to penetrate the inner sleeve 319 and the lining plate 316, and is capable of extending or being retracted relative to the lining plate 316.

In some embodiments, the latch assembly 33 includes a latch body 332 and a latch connecting member 334. The latch connecting member 334 is capable of moving along the length direction D1 of the face plate 314 under driving of the follower 42. The latch body 332 is connected to an end of the latch connecting member 334, and is capable of extending or retracting relative to the lining plate 316.

In some embodiments, the latch body 332 is substantially a cylindrical structure. The latch body 332 includes an installing hole 3321 and a connecting hole such as a pin hole 3323. Among them, the installing hole 3321 is a blind hole disposed along an axial direction of the latch body 332, and is used for installing the latch connecting member 334. The pin hole 3323 is a through-hole disposed along a radial direction of the latch body 332, and is used for communicating with the installing hole 3321. In some embodiments, the pin hole 3323 is disposed on an end of the latch body 332 close to the latch connecting member 334. The pin hole 3323 may be used for a pin to pass through, to make the connecting member such as the pin may be fixedly connected to the latch connecting member 334 by passing through the pin hole 3323, so that the fixed connection between the latch connecting member 334 and the latch body 332 is realized.

In some embodiments, the latch connecting member 334 includes a connecting section 3341 and a transmission section 3343 which are connected to each other. The connecting section 3341 is substantially cylindrical, and the transmission section 3343 is substantially an “L”-shaped plate structure. The connecting section 3341 is provided with a first groove 3341a and a second groove 3341b which are sequentially disposed along the length direction D1 of the face plate 314. The second groove 3341b is farther away from the latch connecting member 334 relative to the first groove 3341a. One of the first groove 3341a and the second groove 3341b is capable of corresponding to the pin hole 3323, to make a pin be capable of passing through the pin hole 3323 and selectively abut against a groove bottom of one of the first groove 3341a and the second groove 3341b, to fixedly connect the latch connecting member 334 to the latch body 332. Since the first groove 3341a and the second groove 3341b are sequentially disposed along the length direction D1 of the face plate 314, so that an extension length of the latch body 332 relative to the lining plate 316 is capable of being adjusted.

According to the technical solution provided by the embodiment of the present disclosure, when a gap (door crack) between a door panel and a door frame where the intelligent lockset 1 is installed is too large, the pin hole 3323 is capable of being made to correspond to the second groove 3341b, to increase the extension length of the latch body 332 relative to the lining plate 316, so that the latch body 332 is capable of matching with the latch slot on the door frame. When the door crack is too small, the pin hole 3323 is capable of being made to correspond to the first groove 3341a, to reduce the extension length of the latch body 332 relative to the lining plate 316, so that the latch body 332 is capable of matching with the latch groove on the door frame. That is, by setting the first groove 3341a and the second groove 3341b, the intelligent lockset 1 is capable of adapting to different sizes of door cracks, thereby expanding applicable range of the intelligent lockset 1.

In some embodiments, the connecting section 3341 also has a communicating slot 3341c, the communicating slot 3341c is in communication with the first groove 3341a and the second groove 3341b. That is, the first groove 3341a communicates with the second groove 3341b via the communication groove 3341c, to make a pin is capable of moving from a position corresponding to the first groove 3341a to a position corresponding to the second groove 3341b via the communicating slot 3341c, and it is not necessary to detach the pin from the first groove 3341a before matching with the second groove 3341b. After the latch body 332 is rotated to a certain angle, the latch body 332 is moved along an axial direction of the latch connecting member 334, so that an extension length of the latch body 332 relative to the lining plate 316 is adjusted, and thus efficiency of adjusting the extension length of the latch body 332 is improved.

In some embodiments, the transmission section 3343 is provided with a notch 3343a, the notch 3343a is capable of matching with the follower 42, to make rotation of the follower 42 drive the transmission section 3343 to move, and thus the latch body 332 is driven to extend or retract relative to the lining plate 316. The notch 3343a penetrates two ends of the transmission section 3343 along a width direction thereof, along a width direction of the latch connecting member 334, one end of the notch 3343a has a large opening, and the other end has a small opening, so that the notch 3343a is substantially trumpet-shaped, to adapt to the rotation of the follower 42.

In some embodiments, a side of the transmission section 3343 away from the face plate 314 is also provided with a protrusion 3343b, and the bottom plate 312 is provided with a guiding slot 3121 extending along the length direction D1 of the face plate 314. The protrusion 3343b is configured to penetrate the guiding slot 3121 to limit moving direction of the latch connecting member 334, so that the latch connecting member 334 is capable of merely moving along the length direction D1 of the face plate 314.

In some embodiments, the follower 42 is rotatably disposed in the lock case 31, and is in transmission connection with the latch assembly 33. Specifically, the follower 42 is capable of extending into the notch 3343a, to make rotation of the follower 42 drive the latch connecting member 334 to move.

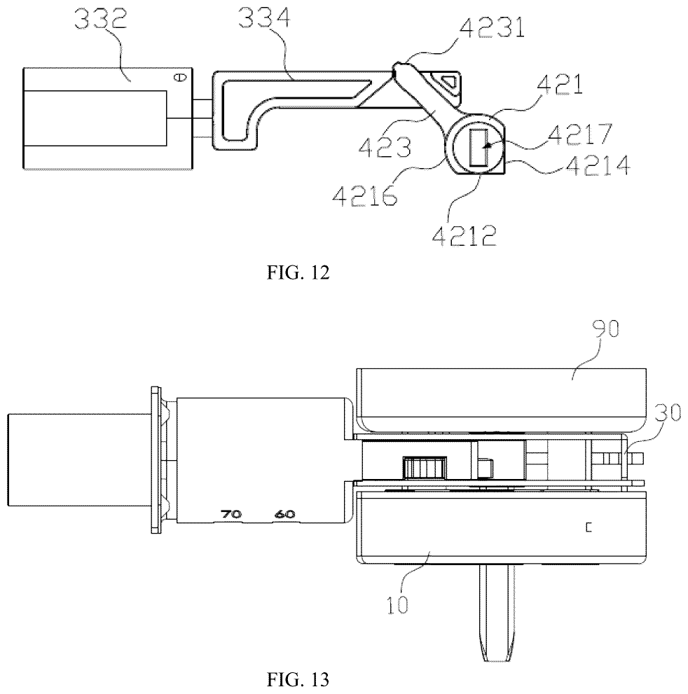

Please refer to FIG. 12, in some embodiments, the follower 42 includes a main body part 421 and a latch shifting rod 423. The main body part 421 is rotatably disposed on the bottom plate 312, the latch shifting rod 423 extends outwards from the main body part 421, and the latch shifting rod 423 is configured to penetrate the latch assembly 33. In some embodiments, the latch shifting rod 423 is integrally disposed with the main body part 421. In other embodiments, the latch shifting rod 423 may also be fixed to the main body part 421 by welding and the like.

In some embodiments, the main body part 421 includes a first side surface 4212, a second side surface 4214 and a third side surface 4216 which are sequentially connected along a circumferential direction of the main body part 421, and the latch shifting rod 423 is convexly disposed on the third side surface 4216. The first side surface 4212 and the second side surface 4214 are flat surfaces, and the third side surface 4216 is an arc-surface. In some embodiments, the first side surface 4212 and the second side surface 4214 are perpendicular to each other. In other embodiments, the first side surface 4212 and the second side surface 4214 may also be acute or obtuse, which may be set according to the actual situation.

In some embodiments, the main body part 421 also includes a first shaft hole 4217. The first shaft hole 4217 penetrates the main body part 421 along an axial direction of the main body part 421. The first shaft hole 4217 is used for the knob shaft 46 to pass through, and matches with the knob shaft 46. In some embodiments, the first shaft hole 4217 is a rectangular hole. In other embodiments, the first shaft hole 4217 may also be a square hole, a hexagonal hole or an oval hole, as long as it is adapted to the knob shaft 46.

In some embodiments, the latch shifting rod 423 is substantially a long rod-shaped structure. In some embodiments, the latch shifting rod 423 is substantially a square rod-shaped structure. In other embodiments, the latch shifting rod 423 may also be a round rod-shaped structure. A side of the latch shifting rod 423 away from the main body part 421 is provided with an abutting inclined surface 4231, the abutting inclined surface 4231 abuts against an edge of the notch 3343a, to make the latch shifting rod 423 stop a movement of the latch assembly 33. Therefore, after the latch assembly 33 extends to the maximum position relative to the lining plate 316, self-locking of the latch assembly 33 is realized, to prevent the latch assembly 33 from retracting under action of external force, so that safety performance of the intelligent lockset 1 is improved.

In some embodiments, the lock body 30 further includes an elastic piece 35. The elastic piece 35 is disposed in the lock case 31, and is capable of selectively abutting against the first side surface 4212 or the second side surface 4214. An end of the elastic piece 35 is fixed to the bottom plate 312, and the other end of the elastic piece 35 abuts against the bottom plate 312. The main part of the elastic piece 35 corresponds to a hollow part of the lock case 31, to make the elastic piece 35 protrude relative to the lock case 31 under an abutting action of the main body part 421. In some embodiments, when the latch body 332 extends relative to the lining plate 316, the elastic piece 35 abuts against the first side surface 4212. When the latch body 332 retracts relative to the lining plate 316, the elastic piece 35 abuts against the second side surface 4214. The abutting action of an elastic member on the follower 42 improves hand feeling for a user when operating the follower 42 to rotate, and thus experience of the user is improved. In some embodiments, the elastic piece 35 may be made of metal. In other embodiments, the elastic piece 35 may also be made of a composite material and the like.

In some embodiments, the transmission assembly 44 is rotatably disposed on the first base 10, and the transmission assembly 44 is rotated relative to the first base 10 under an action of the driving mechanism 50, to drive the follower 42 to rotate through the knob shaft 46, and finally drives the latch body 332 to extend or retract relative to the lining plate 316.

In some embodiments, the transmission assembly 44 includes a rotating seat 441 and a transmission member 443. The rotating seat 441 is rotatably disposed on the first base 10, and is coaxially disposed with the follower 42, and the rotating seat 441 is capable of driving the knob shaft 46 to rotate. The transmission member 443 is in transmission connection with the driving mechanism 50, to make the driving mechanism 50 drive the transmission member 443 to rotate, and thus the transmission member 443 drives the rotating seat 441 to rotate. The transmission member 443 is substantially a circular gear structure. The transmission member 443 is sleeved on the rotating seat 441, which improves integration of the transmission assembly 44, so that a space occupied by the transmission assembly 44 is reduced, then the miniaturization of the intelligent lockset 1 is realized, and thus the convenience of the transportation and the installation of the intelligent lockset 1 is improved.

In some embodiments, the rotating seat 441 includes a rotating body 4412 and a protruding column 4414, the rotating body 4412 and the protruding column 4414 are substantially cylindrical structures. The rotating body 4412 is rotatably disposed on the first base 10, the protruding column 4414 is farther away from the first base 10 relative to the rotating body 4412, and a diameter of the protruding column 4414 is smaller than a diameter of the rotating body 4412.

In some embodiments, the rotating seat 441 is provided with a second shaft hole 4416, the second shaft hole 4416 penetrates the rotating body 4412 and the protruding column 4414 along an axial direction of the rotating seat 441, and the second shaft hole 4416 is used for of the knob shaft 46 to pass through, and matches with the knob shaft 46. The first shaft hole 4217 and the second shaft hole 4416 are coaxially disposed, to make the knob shaft 46 penetrate the first shaft hole 4217 and the second shaft hole 4416 at the same time, so that the rotating seat 441 drives the follower 42 to rotate through the knob shaft 46. In some embodiments, the second shaft hole 4416 is a rectangular hole. In other embodiments, the second shaft hole 4416 may also be a square hole, a hexagonal hole or an oval hole, as long as the second shaft hole 4416 matches with the knob shaft 46.

In some embodiments, an outer peripheral surface of the rotating seat 441 is convexly provided with a boss 4414a. For example, the boss 4414a is convexly disposed on an outer peripheral surface of the protruding column 4414, and the boss 4414a is substantially long strip shape. An inner peripheral surface of the transmission member 443 is provided with an arc-shaped slot 4432, the boss 4414a is at least partially disposed in the arc-shaped slot 4432, and a width of the boss 4414a is smaller than a length of the arc-shaped slot 4432, to make the transmission member 443 drive the rotating seat 441 to rotate after rotating a certain angle.

In some embodiments, the arc-shaped slot 4432 includes a first abutting surface 4432a and a second abutting surface 4432b in an arc extending direction. For example, the boss 4414a abuts against the first abutting surface 4432a, when the driving mechanism 50 drives the transmission member 443 to rotate clockwise, the transmission member 443 drives the rotating seat 441 to rotate clockwise. When the driving mechanism 50 drives the transmission member 443 to rotate counterclockwise, the boss 4414a is away from the first abutting surface 4432a, and the transmission member 443 will not drive the rotating seat 441 to rotate until the boss 4414a abuts against the second abutting surface 4432b, and then the transmission member 443 drives the rotating seat 441 to rotate. In this way, when the knob shaft 46 drives the rotating seat 441 to rotate, the rotating seat 441 will not drive the transmission member 443 to rotate, that is, the mechanical locking or the mechanical unlocking will not drive the driving mechanism 50 to rotate, and thus damage to the driving mechanism 50 is reduced.

In some embodiments, a quantity of the boss 4414a and the arc-shaped slot 4432 are both two, the bosses 4414a are disposed at two ends of a radial direction of the protruding column 4414, and the arc-shaped slots 4432 are disposed at two ends of a radial direction of the transmission member 443.

In some embodiments, the transmission assembly 44 also includes a transmission shifting piece 445 which is sleeved on the rotating seat 441, the integration of the transmission assembly 44 is also improved, and thus the space occupied by the transmission assembly 44 is reduced. The transmission shifting piece 445 is provided with a transmission slot 4451 matching with the boss 4414a, to make rotation of the rotating seat 441 drive the transmission shifting piece 445 to rotate. In some embodiments, the transmission slot 4451 is substantially a U-shaped slot, to match with the long strip-shaped boss 4414a. In some embodiments, when the boss 4414a is a semi-cylindrical shape, the transmission slot 4451 may also be a semi-circular arc-shaped slot. In other embodiments, the transmission slot 4451 may also be other shapes, as long as the transmission slot 4451 matches with the boss 4414a.

In some embodiments, the knob shaft 46 is configured to penetrate the follower 42 and the transmission assembly 44. For example, the knob shaft 46 penetrates the first shaft hole 4217 of the follower 42 and the second shaft hole 4416 of the rotating seat 441 sequentially, to make the rotation of the knob shaft 46 drive the follower 42 and the rotating seat 441 to rotate. In some embodiments, the knob shaft 46 is substantially a plate-shaped structure, and a cross-section of the knob shaft 46 is substantially rectangular. An end of the knob shaft 46 may be fixedly connected to an operating knob installed inside a door, so that the mechanical locking or the mechanical unlocking of the intelligent lockset is realized when a user rotates the operating knob inside the door. Since the rotation of the knob shaft 46 is capable of driving the follower 42 and the rotating seat 441 to rotate, therefore, when the knob shaft 46 matches with a follower of a traditional mechanical lockset, it is capable of driving a latch (also called a bolt) of the traditional mechanical lockset to extend or retract. That is, an overall structure formed by the first base 10, the transmission assembly 44, and the driving mechanism 50 of the embodiment of the present disclosure is adapted to most of the mechanical locksets in the market, thereby enlarging an applicable range of the intelligent lockset 1. In other words, when the lock body 30 provided in the embodiment of the present disclosure is replaced with the traditional mechanical lockset, a mechanical lock is capable of being quickly replaced by an electric lock, so that demand for rapidly replacing the mechanical lock by the electric lock in the market is met, and convenient maintenance and repair of the electric lock in later stage is ensured.

Please refer to FIG. 6, in some embodiments, the driving mechanism 50 is in transmission connection with the transmission assembly 44, to drive the transmission assembly 44 to rotate, and then the transmission assembly 44 drives the follower 42 to rotate through the knob shaft 46. In this way, on the one hand, the driving mechanism 50 drives the transmission assembly 44 to rotate, and then the transmission assembly 44 drives the follower 42 to rotate through the knob shaft 46, so that the latch assembly 33 is driven to extend or retract relative to the lock case 31, and thus the electric locking or the electric unlocking of the intelligent lockset 1 is realized. On the other hand, the knob shaft 46 is capable of being manually rotated to drive the follower 42 to rotate, to realize the mechanical locking or the mechanical unlocking of the intelligent lockset 1. Since the knob shaft 46 is configured to penetrate the follower 42 and the transmission assembly 44, so that the follower 42 and the transmission assembly 44 are disposed along an axial direction of the knob shaft 46, which reduces the space occupied by the follower 42 and the transmission assembly 44, thereby realizing the miniaturization of the intelligent lockset 1, and thus the convenience of the transportation and the installation of the intelligent lockset 1 is improved.

In some embodiments, the driving mechanism 50 includes a driving motor 51 and a reduction gearbox 53. The driving motor 51 outputs torque, and is in transmission connection with the reduction gearbox 53, and the reduction gearbox 53 is in transmission connection with the transmission member 443 of the transmission assembly 44. The reduction gearbox 53 is capable of increasing output torque of the driving mechanism 50. In other embodiments, the driving mechanism 50 may also merely include the driving motor 51.

The driving mechanism 50 is in transmission connection with the transmission member 443, to make the transmission member 443 drive the transmission member 443 to rotate. Specifically, an output gear of the driving mechanism 50 meshes with the transmission member 443.

In some embodiments, the driving mechanism 50 may also be a hydraulic driving mechanism or a pneumatic driving mechanism.

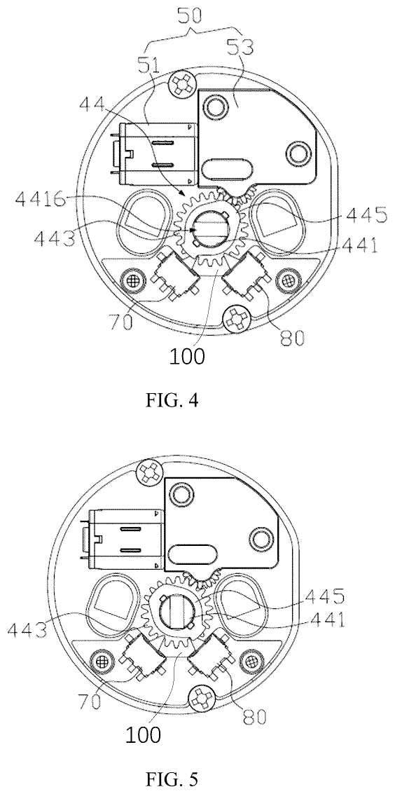

Please continue to refer to FIG. 4 and FIG. 5, in some embodiments, the intelligent lockset 1 also includes a controller 60 (for example a Microprogrammed Control Unit, MCU) and a first switch 70. The first switch 70 is disposed on a rotation path of the transmission assembly 44, and is electrically connected to the controller 60 and the driving mechanism 50, to send a first stopping signal when the transmission assembly 44 drives the latch assembly 33 to extend to a maximum position. The controller 60 controls the driving mechanism 50 to stop running according to the first stopping signal. The first switch 70 indicates the maximum extension position of the latch assembly 33. The first switch 70 is disposed on a rotation path of a transmission shifting piece 445, to make the transmission shifting piece 445 is capable of abutting against the first switch 70, so that the driving mechanism 50 is made to stop operating, thereby avoiding damage to the driving motor 51 which is caused by failure of operation of the driving mechanism 50 to drive the latch assembly 33 to extend, and thus service life of the driving mechanism 50 is prolonged. In the present embodiment, the first switch 70 is a contact switch. In other embodiments, the first switch 70 may also be an inductive switch.

Please continue to refer to FIG. 4 and FIG. 5, in some embodiments, the intelligent lockset 1 also includes a second switch 80, and the first switch 70 and the second switch 80 are disposed at intervals in a circumferential direction of the transmission assembly 44. The second switch 80 is electrically connected to the controller 60 and the driving mechanism 50, to send a second stopping signal when the transmission assembly 44 drives the latch assembly 33 to retract to a maximum position, and the controller 60 controls the driving mechanism 50 to stop running according to the second stopping signal. The second switch 80 is capable of indicating the maximum retraction position of the latch assembly 33. The second switch 80 is disposed on a rotation path of the transmission shifting piece 445, to make the transmission shifting piece 445 be capable of abut against the second switch 80, thereby making the driving mechanism 50 stop running, and thus the damage to the driving motor 51 which is caused by failure of operation of the driving mechanism 50 to drive the latch assembly 33 to retract is avoided, and thus service life of the driving mechanism 50 is prolonged. In this embodiment, the second switch 80 is a contact switch. In other embodiments, the second switch 80 may also be an inductive switch.

It should be noted that, functions of the first switch 70 and the second switch 80 are capable of being interchanged.

Please refer to FIG. 13, in some embodiments, the intelligent lockset 1 also includes a second base 90, the first base 10 and the second base 90 are disposed on two opposite sides of the lock body 30, and the first base 10 and the second base 90 are symmetrically disposed with respect to a central axis of the lock body 30. The central axis of the lock body 30 refers to a central axis of the lock body 30 along the length direction D1 of the face plate 314, and is also an axis of the inner sleeve 319 and the outer sleeve 318. The first base 10 and the second base 90 are symmetrically disposed with respect to the central axis of the lock body 30, so that the overall structure of the intelligent lockset 1 is symmetrical and simple, and thus the appearance consistency of the intelligent lockset 1 is improved. The intelligent lockset 1 may also include a second cover plate (not shown in the figure). The second cover plate is disposed by covering the second base 90, so that the appearance consistency of the intelligent lockset 1 is also improved.

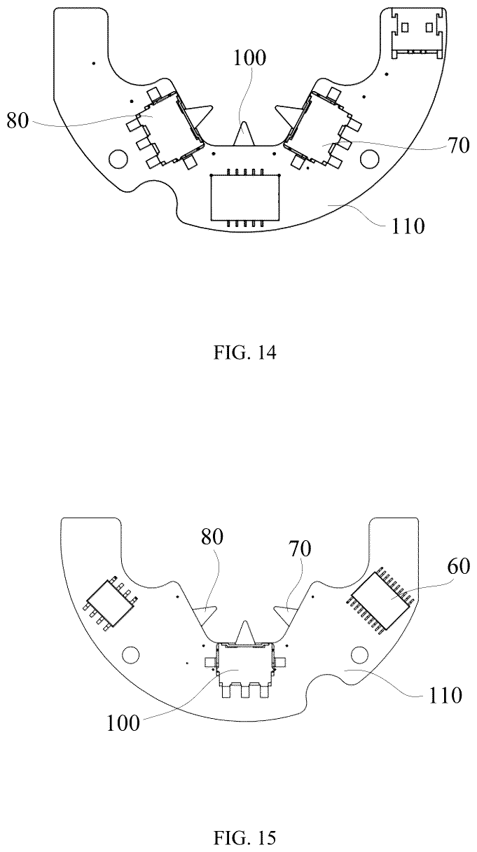

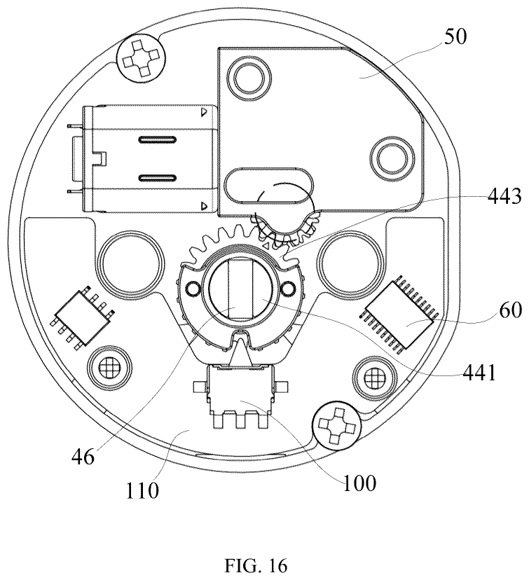

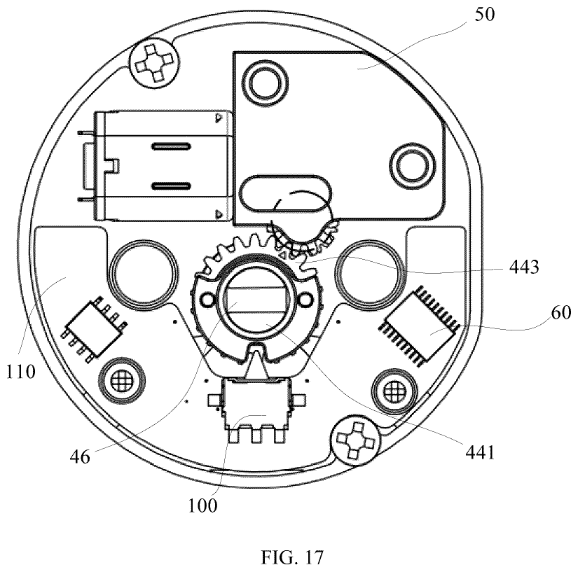

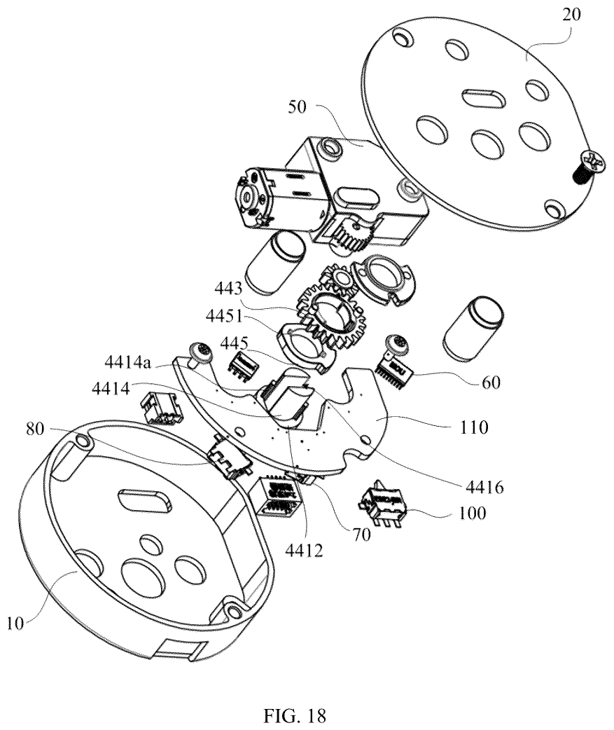

FIG. 14 is a schematic structural diagram of a first switch, a second switch, a resetting detection switch and a controller of an intelligent lockset according to another embodiment provided by the present disclosure. FIG. 15 is another schematic structural diagram of the first switch, the second switch, the resetting detection switch and the controller of the intelligent lockset shown in FIG. 14. FIG. 16 is a schematic structural diagram of a knob of an intelligent lockset in an unlocked state according to another embodiment provided by the present disclosure. FIG. 17 is another schematic structural diagram of the knob of the intelligent lockset in a locked state which is shown in FIG. 16. FIG. 18 is an exploded diagram of a first base, a transmission assembly, and a driving mechanism of an intelligent lockset according to another embodiment provided by the present disclosure. A difference between the embodiments shown in FIGS. 14 to 18 and the above-mentioned embodiments is that the controller 60 and the resetting detection switch 100 are also shown in the figures, and the rest of the structures are the same as described in the above-mentioned embodiment, which will not be repeated herein.

Please continue to refer to FIG. 4, FIG. 5 and FIG. 14 to FIG. 18, in some embodiments, the intelligent lockset 1 also includes a resetting detection switch 100. The resetting detection switch 100 is disposed on a rotation path of the transmission member 443, and is electrically connected to the drive motor 51 of the driving mechanism 50, to send a resetting normal signal when the transmission member 443 is reset to an initial state, and the controller 60 controls the driving mechanism 50 (for example a driving motor 51) to stop running according to the resetting normal signal. The resetting detection switch 100 may be used for confirming whether the transmission mechanism 40 and the driving mechanism 50 (for example, the driving motor 51) are returned to the initial state after unlocking and locking, to avoid abnormal operations of the transmission mechanism and the driving motor 51.

For example, as shown in FIG. 4 and FIG. 5, the resetting detection switch 100 is disposed on the transmission path of the transmission member 443, and is provided with a contact which is capable of contacting with the transmission member 443, and the resetting detection switch 100 is provided with a force sensor. When the transmission member 443 is reset to the initial position after the latch assembly 33 is extended to the maximum position or retracted to the minimum position, the transmission member 443 will contact with the resetting detection switch 100 for the second time and is subjected to a force opposite a force (a force on the contact when the latch assembly 33 is extended or retracted) when the latch assembly 33 is extended or retracted. At this time, the resetting detection switch 100 sends a resetting normal signal to the controller 60 according to a force change signal detected by the force sensor. The controller 60 controls the driving mechanism 50, such as the driving motor 51, to stop running according to the reset normal signal. In this way, the transmission member 443 and the driving motor 51 may be normally reset. At the same time, since the transmission member 443 is provided with the arc-shaped slot 4432, it may be ensured that the transmission member 443 will not contact with the boss 4414a when it is reset, which will cause the latch assembly 33 to deviate from the locked or unlocked state and cause a misoperation.

For another example, as shown in FIG. 16 and FIG. 17, a side of the transmission member 443 close to the first base 10 is provided with a resetting piece 120. The resetting piece 120 has a gap with the transmission member 443 along a direction the transmission member 443 pointing to the first base 10. The resetting piece 120 is retractably connected to the transmission member 443, to extend out and contact with the resetting detection switch 100 when the transmission member 443 is reset in place. At this time, the contact provided on the resetting detection switch 100 may be a pressure sensitive member. When the transmission member 443 is reset to the initial position, the transmission member 443 will contact with the contact of the resetting detection switch 100, and the resetting detection switch 100 will send the resetting normal signal to the controller 60 according to a pressure sensitive signal. The controller 60 controls the driving motor 51 to stop running according to the resetting normal signal. Therefore, the transmission member 443 and the driving motor 51 may be normally reset. At the same time, since the transmission member 443 is provided with the arc-shaped slot 4432, it may be ensured that the transmission member 443 will not touch with the boss 4414a when it is reset, which will cause the latch assembly 33 to deviate from the locked or unlocked state and cause the misoperation.

The resetting piece 120 may be retractably connected to the transmission member 443 through a torsion spring, or in other suitable ways.

As shown in FIG. 14 to FIG. 16, in some embodiments, the first switch 70, the second switch 80, the resetting detection switch 100 and the controller 60 of the intelligent lockset 1 are provided on a Printed Circuit Board Assembly (PCBA) board 110. Specifically, the first switch 70 and the second switch 80 are disposed on a first surface of the PCBA board 110, and the resetting detection switch 100 is disposed on a second surface opposite to the first surface of the PCBA board 110. Certainly, the first switch 70, the second switch 80 and the resetting detection switch 100 may also be arranged on a same surface of the PCBA board 110.

In some embodiments, the controller 60 is electrically connected to the driving mechanism 50, such as the driving motor 51, to monitor a current in the driving motor 51, and judge whether the driving motor 51 is locked-motor by the current, to confirm whether the intelligent lockset 1 is suitable for a left-handed door or a right-handed door left or right, and whether the intelligent lockset 1 is installed correctly. For example, when the rotation is locked-motor, the motor 51 continues rotating, thus causing damage or destroy to the transmission assembly and the motor 51. For example, in some embodiments, the controller 60 is electrically connected with the driving motor 51. When the controller 60 determines that the driving mechanism 50 is locked-motor according to the current, the controller 60 sends a reversing signal to the driving mechanism 50, and the driving mechanism 50 rotates reversely according to the reversing signal, to realize automatic reversing, to make the extension direction and the retraction direction of the bolt assembly 33 is adapted to an opening mode of a door. In this way, the intelligent lockset 1 may be conveniently adapted to application scenarios of the left-handed door or the right-handed door, and the operation is convenient.

According to the embodiment of the present disclosure, when the intelligent lockset 1 is used for the first time after installation, the driving motor 51 starts to work, the controller 60 monitors the current in the driving motor 51. When a significant increase in the current is monitored, it indicates that the driving motor 51 is locked-rotor, so that the intelligent lockset 1 is installed incorrectly. For example, a door leaf on which the intelligent lockset 1 is installed is a left-handed door, but the intelligent lockset 1 is suitable for a right-handed door. When it is detected that the current is relatively stable, it indicates that the driving motor 51 is not locked-rotor, and the intelligent lockset 1 is installed correctly. For example, a door leaf on which the intelligent lockset 1 is installed is a left-handed door, and then the intelligent lockset 1 is suitable for a left-handed door.

In summary, the intelligent lockset 1 provided by the present disclosure includes the first base 10, the lock body 30, the transmission mechanism 40 and the driving mechanism 50. The lock body 30 includes the lock case 31 and the latch assembly 33. The lock case 31 is connected to the first base 10, and the latch assembly 33 is movably disposed in the lock case 31, and is capable of extending or retracting relative to the lock case 31. The transmission mechanism 40 includes the follower 42, the transmission assembly 44 and the knob shaft 46. The follower 42 is rotatably disposed in the lock case 31, and is in transmission connection with the latch assembly 33. The transmission assembly 44 is rotatably disposed on the first base 10, and the knob shaft 46 is configured to penetrate the follower 42 and the transmission assembly 44. The driving mechanism 50 is in transmission connection with the transmission assembly 44, to drive the transmission assembly 44 to rotate, and the transmission assembly 44 drives the follower 42 to rotate through the knob shaft 46.

In this way, on the one hand, the driving mechanism 50 may drive the transmission assembly 44 to rotate, and then the transmission assembly 44 drives the follower 42 to rotate through the knob shaft 46, so that the latch assembly 33 is driven to extend or retract relative to the lock case 31, and thus the electric locking or the electric unlocking of the intelligent lockset 1 is achieved. On the other hand, the knob shaft 46 may be manually rotated to drive the follower 42 to rotate, so that the mechanical locking or the mechanical unlocking of the intelligent lockset 1 is achieved. The intelligent lockset 1 is capable of being applied to the scenario of the left-handed door or the scenario of the right-handed door, so that different requirements of the opening of the door is met. Since the knob shaft 46 is configured to penetrate the follower 42 and the transmission assembly 44, so that the follower 42 and the transmission assembly 44 are disposed along the axis of the knob shaft 46, then the space occupied by the follower 42 and the transmission assembly 44 is reduced, thereby realizing the miniaturization of the intelligent lockset 1, and thus the convenience of the transportation and the installation of the intelligent lockset 1 is improved.

In addition, after the intelligent lockset 1 is installed, when it is used for the first time, the driving motor 51 starts to work, the controller 60 monitors the current in the driving motor 51. When the significant increase in the current is monitored, it indicates that the driving motor 51 is locked-rotor, the extension and retraction directions of the latch assembly 33 does not match with the opening manner of the door, and the controller 60 determines that that the intelligent lockset 1 is installed incorrectly according to the received current signal. For example, the door leaf on which the intelligent lockset 1 is installed is a left-handed door, but the installed intelligent lockset 1 is suitable for a right-handed door, it does not match with the opening manner of the door. At this moment, the controller 60 sends a reversing signal to the driving mechanism 50, and the driving mechanism 50 is rotated reversely according to the reversing signal, to achieve automatic reversing, to make the extension and retraction directions of the latch assembly 33 match with the opening manner of the door. When it is monitored that the current is relatively stable, it indicates that the drive motor 51 is not locked-rotor, and the extension and retraction directions of the latch assembly 33 match with the opening manner of the door, the controller 60 determines that the intelligent lockset 1 is installed correctly according to the received current signal, and matches with the opening manner of the door. For example, the door leaf on which the intelligent lockset 1 is installed is a left-handed door, and the intelligent lockset 1 is suitable for the left-handed door.

Specifically, if the intelligent lockset 1 is installed incorrectly, when the transmission assembly 44 drives the latch assembly 33 to extend to the maximum position, the transmission shifting piece 445 does not abut against the first switch 70. Therefore, when the transmission assembly 44 drives the latch assembly 33 to extend to the maximum position, the first switch 70 is not capable of sending the first stopping signal, resulting in the controller 60 is unable to control the driving mechanism 50 to stop running according to the first stopping signal, and thus causing the significant increase in the current. Alternatively, when the transmission assembly 44 drives the latch assembly 33 to retract to the maximum position, the transmission shifting piece 445 does not abut against the second switch 80. Therefore, when the transmission assembly 44 drives the latch assembly 33 to retract to a maximum position, the second switch 80 is not capable of sending the second stopping signal, resulting in the controller 60 is unable to control the driving mechanism 50 to stop running according to the second stopping signal, and thus causing a significant increase in the current. At this point, the controller 60 sends the reversing signal to the driving mechanism 50, and the driving mechanism 50 is rotated reversely according to the reversing signal, to achieve automatic reversing, so that the extension and retraction directions of the latch assembly 33 match with the opening manner of the door.

After the reversing, the functions of the first switch 70 and the second switch 80 are correspondingly interchanged. Specifically, when the transmission assembly 44 drives the latch assembly 33 to extend to the maximum position, the transmission shifting piece 445 abuts against the second switch 80, the second switch 80 sends out a first stopping signal, and the controller 60 controls the driving mechanism 50 to stop running according to the first stopping signal. When the transmission assembly 44 drives the latch assembly 33 to retract to the maximum position, the transmission shifting piece 445 abuts against the first switch 70, the first switch 70 sends out a second stopping signal, and the controller 60 controls the driving mechanism 50 to stop running according to the second stopping signal.

In the embodiment of the present disclosure, the driving mechanism 50 is electrically connected to the controller 60. When the controller 60 determines that the driving mechanism 50 is locked-rotor according to the current, it sends out a reversing signal to the driving mechanism 50, and the driving mechanism 50 is rotated reversely according to the reversing signal, to achieve automatic reversing, so that the extension and retraction directions of the latch assembly 33 match with the opening manner of the door. In this way, the intelligent lockset 1 is capable of conveniently adapted to the scenario of the left-handed door or scenario of the right-handed door disclosure, and the operation is convenient.

In addition, in the embodiments of the present disclosure, the resetting detection switch 100 may also be provided. The resetting detection switch 100 is disposed on the transmission path of the transmission member 443, and is electrically connected with the controller 60. When the transmission member 443 is reset to the initial state, the resetting normal signal may be sent out, and then the controller 60 controls the driving mechanism 50 to stop running according to the resetting normal signal, so that the misoperation may be avoided during normal resetting.

Taking the driving mechanism as an electric motor as an example, the function of automatic reversing of the intelligent lockset 1 is introduced above. When the driving mechanism is a hydraulic driving mechanism or a pneumatic driving mechanism, the controller 60 monitors hydraulic pressure or the pneumatic pressure correspondingly, and then the controller 60 sends a reversing signal to the driving mechanism 50 according to the pressure signal, and the driving mechanism 50 performs corresponding operation according to the reversing signal, to achieve automatic reversing. The structures of the hydraulic driving mechanism and the pneumatic driving mechanism are conventional, and will not be described herein.

In a second aspect, the present disclosure provides a door, the door is provided with the intelligent lockset 1 mentioned in the first aspect.

The door provided by the present disclosure is provided with the intelligent lockset above-mentioned, and has the corresponding technical effects. The specific technical effects refer to the description of the intelligent lockset 1, and will not be repeated herein.

In the present disclosure, unless otherwise explicitly specified or limited, a term such as “assembly” and the like should be construed in a broad sense. For example, it may be a fixed connection, a detachable connection or an integral connection; it may be a mechanical connection; or it may be a direct connection, or it may be an indirect connection by using an intermediate medium, or it may also be an internal connection between two elements, or it may be merely a surface contact, or a surface contact connection by an intermediate medium. For a person skilled in the art, the specific meaning of the above-mentioned term in the present disclosure may be understood according to the specific situation.

In addition, terms such as “first”, “second” and the like are merely used for distinguishing description, and should not be understood to refer to specific or a specific structure. The description of term “some embodiments” means that a specific feature, a structure, a material or a characteristic described in combination with this embodiment or example are included in at least one embodiment of the present disclosure. In the present disclosure, the illustrative description of the terms does not necessarily refer to the same embodiment or example. Furthermore, the described specific feature, structure, material or characteristic may be combined in any appropriate manner in any one or more embodiments or examples. In addition, a person skilled in the art is capable of combining and integrating the different embodiments or examples and the features of the different embodiments or examples described in the present disclosure without contradicting with each other.

The above-mentioned embodiments merely express several implementations of the present disclosure, the description thereof is relatively specific and detailed, but it should not be understood as a limitation to the patent scope of the present disclosure. It should be pointed out that, for a person skilled in the art, some modifications and improvements may also be made without departing from the concept of the present disclosure, which fall within the protection scope of the present disclosure patent. Therefore, the protection scope of the present disclosure should be determined by the claims attached.

What is claimed is:

1. An intelligent lockset, comprising:
a first base;
a lock body, comprising a lock case and a latch assembly, the lock case being connected to the first base, and the latch assembly being movably disposed in the lock case and being capable of extending or retracting relative to the lock case; and
a transmission mechanism, comprising a follower, a transmission assembly and a knob shaft, the follower being rotatably disposed in the lock case and being in transmission connection with the latch assembly, the transmission assembly being rotatably disposed on the first base, the knob shaft being configured to penetrate the follower and the transmission assembly, and the transmission assembly being capable of rotating under driving of a driving mechanism, and driving the follower to rotate through the knob shaft.

2. The intelligent lockset according to claim 1, wherein the intelligent lockset further comprises a controller and a first switch, the first switch is disposed on a rotation path of the transmission assembly, and is electrically connected to the controller and the driving mechanism, to send a first stopping signal when the transmission assembly drives the latch assembly to extend to a maximum extension position, and the controller controls the driving mechanism to stop running according to the first stopping signal.

3. The intelligent lockset according to claim 1, wherein the intelligent lockset further comprises a controller and a second switch, the second switch is disposed on a rotation path of the transmission assembly, and is electrically connected to the controller and the driving mechanism, to send a second stopping signal when the transmission assembly drives the latch assembly to retract to a maximum retraction position, and the controller controls the driving mechanism to stop running according to the second stopping signal.

4. The intelligent lockset according to claim 2, wherein the intelligent lockset further comprises a second switch disposed at intervals with the first switch in a circumferential direction of the transmission assembly, the second switch is electrically connected to the controller and the driving mechanism, to send a second stopping signal when the transmission assembly drives the latch assembly to retract to a maximum retraction position, and the controller controls the driving mechanism to stop running according to the second stopping signal.

5. The intelligent lockset according to claim 1, wherein the transmission assembly comprises a rotating seat and a transmission member, the rotating seat is rotatably disposed on the first base, and is coaxially disposed with the follower, the knob shaft is further configured to penetrate through the rotating seat, the transmission member is sleeved on the rotating seat, and the driving mechanism is in transmission connection with the transmission member, to make the transmission member drive the rotating seat to rotate.

6. The intelligent lockset according to claim 5, wherein an outer peripheral surface of the rotating seat is convexly provided with a boss, an inner peripheral surface of the transmission member is provided with an arc-shaped slot, the boss is at least partially disposed in the arc-shaped slot, and a width of the boss is smaller than a length of the arc-shaped slot.

7. The intelligent lockset according to claim 6, wherein the rotating seat comprises a rotating body and a protruding column, the rotating body and the protruding column are substantially cylindrical structures, the protruding column is farther away from the first base relative to the rotating body, a diameter of the protruding column is smaller than a diameter of the rotating body, and the boss is convexly disposed on an outer peripheral surface of the protruding column, wherein,
the rotating body is rotatably disposed on the first base, and is coaxially disposed with the follower, the transmission member is sleeved on the rotating body, and the knob shaft is configured to penetrate the rotating body and the protruding column.

8. The intelligent lockset according to claim 6, wherein the transmission assembly further comprises a transmission shifting piece which is sleeved on the rotating seat, the transmission shifting piece is provided with a transmission slot matching with the protrusion, the intelligent lockset further comprises a first switch and a second switch, the first switch is configured to indicate a maximum extension position of the latch assembly, the second switch is configured to indicate a maximum retraction position of the latch assembly, and the first switch and the second switch are disposed on a rotation path of the transmission shifting piece.

9. The intelligent lockset according to claim 1, wherein the lock case comprises a bottom plate and a face plate, the face plate is covered on the bottom plate, the follower comprises a main body part and a latch shifting rod extending outwards from the main body part, the main body part is rotatably disposed on the bottom plate, and the latch shifting rod is configured to penetrate the latch assembly.

10. The intelligent lockset according to claim 9, wherein the main body part comprises a first side surface, a second side surface and a third side surface which are sequentially connected along a circumferential direction of the main body part, the latch shifting rod is convexly disposed on the third side surface, the lock body further comprises an elastic piece, and the elastic piece is disposed in the lock case, and selectively abuts against the first side surface or the second side surface.

11. The intelligent lockset according to claim 9, wherein the lock case further comprises a lining plate, an outer sleeve and an inner sleeve, the outer sleeve is sleeved on the inner sleeve, the lining plate is connected to a side of the outer sleeve, and the latch assembly is configured to penetrate the inner sleeve and the lining plate, and is capable of extending or retracting relative to the lining plate.

12. The intelligent lockset according to claim 11, wherein the latch assembly comprises a latch body and a latch connecting member, the latch connecting member is capable of moving along a length direction of the face plate under driving of the follower, the latch body is connected to an end of the latch connecting member, and is capable of extending or retracting relative to the lining plate, wherein
the latch body comprises an installing hole and a connecting hole, the installing hole is disposed along an axial direction of the latch body, and is configured for installing the latch body to the latch connecting member, and the connecting hole is disposed along a radial direction of the latch body, on an end of the latch body close to the latch connecting member, and communicates with the installing hole, to make the connecting member pass through the connecting hole and be fixedly connected to the latch connecting member.

13. The intelligent lockset according to claim 12, wherein the latch connecting member comprises a connecting section and a transmission section which are connected to each other, and the connecting member is capable of being connected to the connecting section by passing through the connecting hole.

14. The intelligent lockset according to claim 13, wherein the connecting section is provided with a first groove and a second groove which are sequentially disposed along a length direction of the face plate, wherein
the second groove is farther away from the latch connecting member relative to the first groove, and one of the first groove and the second groove is capable of corresponding to the connecting hole, to make the connecting member selectively abut against a groove bottom of one of the first groove and the second groove by passing through the connecting hole, to fixedly connect the latch connecting member to the latch body.

15. The intelligent lockset according to claim 14, wherein the connecting section is further provided with a communicating slot, and the first groove communicates with the second groove through the communicating slot, to make the connecting member be capable of moving from a position corresponding to the first groove to a position corresponding to the second groove through the communicating slot.

16. The intelligent lockset according to claim 13, wherein a side of the transmission section away from the face plate is further provided with a protrusion, the bottom plate is provided with a guiding slot extending along a length direction of the face plate, and the protrusion is configured to penetrate the guiding slot, and is configured to limit a moving direction of the latch connecting member, to make the latch connecting member move along the length direction of the face plate.

17. The intelligent lockset according to claim 1, wherein the intelligent lockset further comprises a second base, the first base and the second base are disposed on two opposite sides of the lock body, and the first base and the second base are symmetrically disposed with respect to a central axis of the lock body.

18. The intelligent lockset according to claim 1, wherein the intelligent lockset further comprises a resetting detection switch and a controller, the resetting detection switch is disposed on a rotation path of the transmission member, and is electrically connected to the driving mechanism, to send a resetting normal signal when the transmission member is reset to an initial state, and the controller controls the driving mechanism to stop running according to the resetting normal signal.

19. The intelligent lockset according to claim 1, wherein the intelligent lockset further comprises a controller, the controller is electrically connected to the driving mechanism, and is capable of determining whether the driving mechanism is locked-rotor according to a current signal of the driving mechanism, when the controller determines that the driving mechanism is locked-rotor according to the current signal, the controller sends a reversing signal to the driving mechanism, the driving mechanism is rotated reversely according to the reversing signal, to make an extension direction and a retraction direction of the latch assembly match with an opening manner of a door, to achieve automatic reversing.

20. A door comprising the intelligent lockset according to claim 1.
